(19) United States
(12) Patent Application Publication
(10) Pub. No.: US 2025/0202231 A1
(43) Pub. Date: Jun. 19, 2025

(54) ELECTRICAL DEVICE

(71) Applicant: CANON KABUSHIKI KAISHA, Tokyo (JP)

(72) Inventors: TAKUHIRO OGUSHI, Kanagawa (JP); HIDEYUKI UEKI, Tokyo (JP); YOSUKE EZUMI, Ibaraki (JP); YUKINORI NISHIKAWA, Kanagawa (JP); TAKAHIRO AIDA, Tokyo (JP)

(21) Appl. No.: 19/065,076

(22) Filed: Feb. 27, 2025

Related U.S. Application Data
(63) Continuation of application No. PCT/JP2023/025226, filed on Jul. 7, 2023.

(30) Foreign Application Priority Data
Sep. 21, 2022 (JP) 2022-150528

(51) Int. Cl. H02J 3/00

(52) U.S. Cl. CPC H02J 3/0012; H02J 2310/60

(57) ABSTRACT

An electrical device includes a controlling unit configured to control the electrical device, a power supplying unit configured to supply power to the controlling unit, and a power controlling unit configured to control supply and interruption of power with regard to the controlling unit by the power supplying unit. The controlling unit and the power controlling unit are configured to perform command-based communication. The power controlling unit instructs the power supplying unit to interrupt the supply of power to the controlling unit based on a shutdown command received from the controlling unit.

### CROSS-REFERENCE TO RELATED APPLICATIONS

This application is a Continuation of International Patent Application No. PCT/JP2023/025226, filed Jul. 7, 2023, which claims the benefit of Japanese Patent Application No. 2022-150528, filed Sep. 21, 2022, both of which are hereby incorporated by reference herein in their entirety.

### BACKGROUND OF THE INVENTION

### Field of the Invention

The present invention relates to an electrical device.

### Description of the Related Art

In order to reduce the power consumption of an electrical device, a technology is known that enables the power state of the electrical device to transition between a normal state and a power saving state in which the power consumption is lower than that in the normal state. U.S. Pat. No. 10,642,331 discloses a sensor device in which, when sensor output is detected, a data storage element changes its state, and thus a power circuit that supplies power to a processor is enabled so as to supply power to the processor. In this sensor device, in response to a control signal from the processor, the state of the data storage element is changed, and thus the power circuit is disabled so as to stop the supply of power to the processor.

In order to protect electrical circuitry from a power outage, some electrical devices include an under voltage lockout (UVLO) function. According to the UVLO function, if a power outage occurs and the commercial power voltage drops, the electrical device stops operating. When the commercial power supply is restored after the power outage, the electrical device is initialized and operates normally. On the other hand, if the power outage is a momentary power interruption that lasts only a very short time, some circuits stop due to the function of the UVLO, whereas other circuits are not influenced by the UVLO and may continue to operate. When communication between circuits is carried out using a signal line on which a signal changes between a high level and a low level, a momentary power interruption causes the signal on the signal line to fall to the low level. If the circuit receiving the signal is not influenced by the UVLO and continues to operate, the circuit may erroneously detect the low level signal caused by the momentary power interruption as a communication signal and accordingly perform an erroneous operation.

### SUMMARY OF THE INVENTION

The present invention provides a technology that is related to power state control and is for preventing an erroneous operation from being performed when a momentary power interruption occurs.

According to an aspect of the present invention, there is provided an electrical device comprising: a controlling unit configured to control the electrical device; a power supplying unit configured to supply power to the controlling unit; and a power controlling unit configured to control supply and interruption of power with regard to the controlling unit by the power supplying unit, wherein the controlling unit and the power controlling unit are configured to perform command-based communication, and the power controlling unit instructs the power supplying unit to interrupt the supply of power to the controlling unit based on a shutdown command received from the controlling unit.

Further features of the present invention will become apparent from the following description of exemplary embodiments with reference to the attached drawings.

### BRIEF DESCRIPTION OF THE DRAWINGS

FIG. 1 is an external view of an electrical device according to an embodiment of the present invention.

FIG. 2 is an illustrative diagram showing an internal mechanism of the electrical device of FIG. 1.

FIG. 3 is a block diagram of a control unit of the electrical device of FIG. 1.

FIG. 4A is an illustrative diagram of a command.

FIG. 4B is an illustrative diagram of a comparative example.

FIG. 5 is an illustrative diagram of operations when the power is turned on.

FIG. 6 is an illustrative diagram of operations when a power key is operated.

FIG. 7 is an illustrative diagram of operations when the power key is operated.

FIG. 8 is an illustrative diagram of operations when a power outage occurs.

FIG. 9 is an illustrative diagram of operations when a momentary power interruption occurs in a comparative example.

FIG. 10 is an illustrative diagram of operations when a momentary power interruption occurs.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <Overview of Electrical Device>

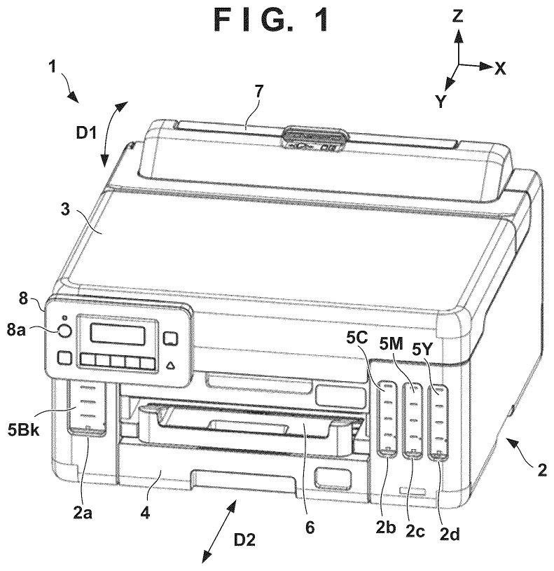

FIG. 1 is an external view of an electrical device 1 according to an embodiment of the present invention, as viewed from the front side. The electrical device 1 of the present embodiment is an inkjet printing apparatus that ejects liquid ink to perform printing on a printing medium, but the present invention is also applicable to various electrical devices other than inkjet printing apparatuses. In the figures, arrows X and Y indicate horizontal directions that are orthogonal to each other, and an arrow Z indicates the up-down direction (the direction of gravity). The X direction is the width direction (left-right direction) of the electrical device 1. The Y direction is the depth direction of the electrical device 1.

Note that “printing” includes not only formation of significant information such as a character or graphic pattern but also formation of an image, design, or pattern on print media in a broader sense and processing of print media regardless of whether the information is significant or insignificant or has become obvious to allow human visual perception. Also, in this embodiment, “printing medium” is assumed to be sheet-shaped paper but may be a fabric, a plastic film, or the like.

The electrical device 1 has a flattened rectangular parallelepiped shape as a whole, and includes an apparatus body 2, a cover 3, and a cassette-type stacking portion 4. The cover 3 is provided so as to cover the upper portion of the apparatus body 2 and constitutes the top portion of the electrical device 1. The cover 3 is a movable portion that can be operated by a user, and can be opened and closed in the direction of an arrow D1. FIG. 1 shows the cover 3 in a closed state. When the cover 3 changes to an open state, the internal mechanism of the apparatus body 2 can be exposed to the outside for maintenance or the like. The stacking portion 4 is a tray on which printing media are stacked, and is a movable portion that can be operated by the user and can be pulled out from and mounted in (pushed into) the apparatus body 2 in the direction of an arrow D2. A discharge portion 6, which is for discharging a printing medium on which printing was performed, is formed at the front of the electrical device 1. An operation unit 8 that accepts operations performed by a user is also provided at the front of the electrical device 1. The operation unit 8 has a touch panel type of display unit and a power key 8a. In the present embodiment, the power key 8a is a push button type of switch. By operating the power key 8a, the user can issue a power-on instruction and a power-off instruction to the electrical device 1.

A housing forming the outer walls of the apparatus body 2 has a plurality of window portions 2a to 2d. A user can visually check the internal configuration of the apparatus body 2 through the window portions 2a to 2d. In the present embodiment, the user can visually check the remaining amount of liquid contained in containers 5Bk, 5C, 5M, and 5Y (hereinafter, simply called the containers 5 when collectively referred to or when no distinction is made between them) through window portions 2a to 2d. The containers 5 are ink tanks that contain liquid ink, and different types of ink are contained in the four containers 5. In the case of the present embodiment, the container 5Bk contains black ink, the container 5C contains cyan ink, the container 5M contains magenta ink, and the container 5Y contains yellow ink. Also, the number of types of ink is not limited to four as in the present embodiment, and may be one type or a number of types other than four types, and the number of containers 5 need only be greater than or equal to the number of types of liquid ink.

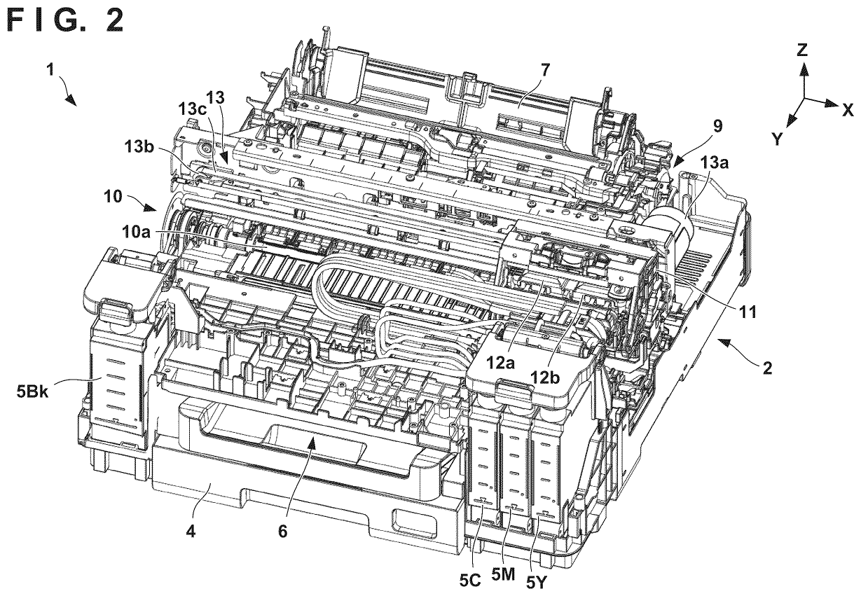

FIG. 2 is an illustrative diagram showing the internal mechanism of the electrical device 1. The electrical device 1 includes ejection heads 12a and 12b that eject liquid (hereinafter, simply called the containers 5 when collectively referred to or when no distinction is made between them). In the present embodiment, the ejection head 12a is a printing head that performs printing by ejecting ink supplied from the container 5Bk onto a printing medium, and the ejection head 12b is a printing head that performs printing by ejecting ink supplied from the containers 5C to 5Y onto a printing medium. The ejection heads 12 each have an ejection face on which a plurality of nozzles for ejecting ink are formed. Each nozzle is provided with, for example, an electrothermal conversion element (heater), which is heated when supplied with power to cause the formation of bubbles in the ink, and the resulting bubbling energy causes the ink to be ejected.

The ejection heads 12 are mounted on a carriage 11. The carriage 11 is moved back and forth in the X direction (main scanning direction) by a drive unit 13. The drive unit 13 includes a drive pulley and a driven pulley (only the driven pulley 13b is shown in FIG. 2) that are spaced apart in the X direction, an endless belt 13c wound around the pulleys, and a carriage motor 13a serving as a drive source for rotating the drive pulley. The carriage 11 is coupled to the endless belt 13c, and the carriage 11 moves in the X direction when the endless belt 13c moves. As the carriage 11 moves, ink is ejected from the ejection heads 12 onto the printing medium, thereby printing an image. This operation is sometimes called printing scanning.

As described above, the electrical device 1 of the present embodiment is a serial-type inkjet printing apparatus in which the ejection heads 12 are mounted on the carriage 11 that moves back and forth. However, the present invention can also be applied to other printing apparatuses, such as an inkjet printing apparatus that includes a “full line” head ejection head (printing head) provided with a plurality of nozzles that eject liquid over an area corresponding to the width of the printing medium.

The electrical device 1 includes a feeding unit 9 and a conveying unit 10 that convey printing media. The feeding unit 9 includes a feeding mechanism (not shown) that feeds printing media from the stacking portion 4 or a tray 7 onto which printing media have been stacked. The feeding mechanism includes, for example, a feeding roller that feeds the printing media, and a feeding motor serving as a drive source that rotates the feeding roller. The conveying unit 10 is a mechanism for conveying the printing media fed from the feeding unit 9 in the Y direction (sub scanning direction). The conveying unit 10 includes a conveying roller 10a and a conveying motor serving as a drive source for rotating the conveying roller 10a. A pinch roller (not shown) is in pressure contact with the conveying roller 10a, and a printing medium is sandwiched in the nip region between them. The printing medium is intermittently conveyed toward the ejection head 12 by the rotation of the conveying roller 10a. The printing operation is performed by alternately repeating the printing medium conveying operation, which is performed by the conveying unit 10, and printing scanning.

### <Control Unit>

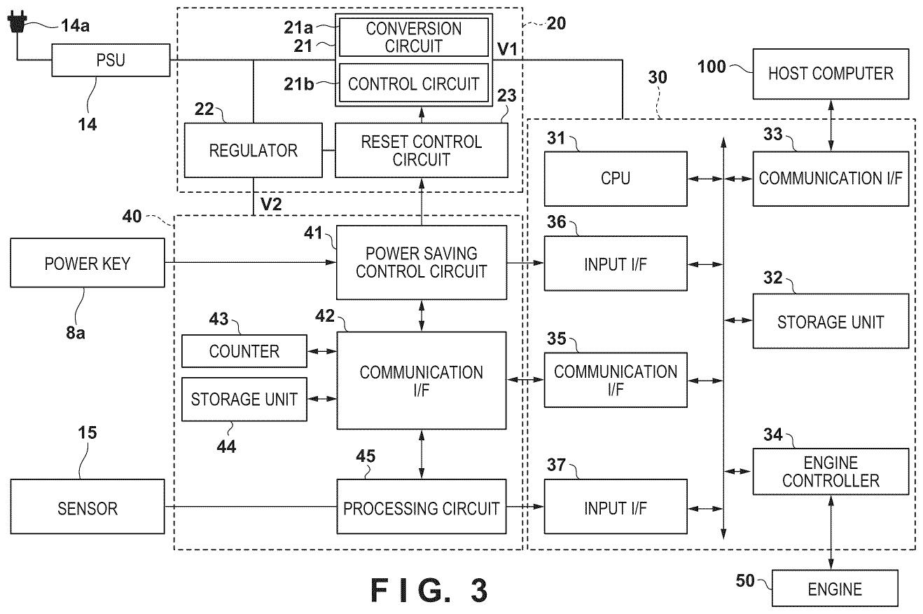

FIG. 3 is a block diagram of a control unit provided in the electrical device 1. The control unit is an electrical circuit that controls the electrical device 1. The control unit includes a power supply unit 20, a system control unit 30, and a power control unit 40.

The system control unit 30 is a control circuit (e.g., an ASIC) that performs overall control of the electrical device 1. The CPU 31 is a processor that, for example, controls operations of the electrical device 1 and controls the processing of data. The CPU 31 executes a program stored in a storage unit 32 to perform overall control of the electrical device 1. The storage unit 32 is constituted by a semiconductor memory (e.g., a ROM or a RAM). The storage unit 32 stores programs executed by the CPU 31 and various data required for processing, such data received from a host computer 100. An engine controller 34 includes, for example, a driver that controls an engine 50. The engine 50 includes components related to the printing operation (e.g., the ejection head 12, the feeding unit 9, the conveying unit 10, and various sensors).

The host computer 100 is, for example, a personal computer or a mobile terminal (such as a smartphone or tablet terminal) used by a user. A printer driver for performing communication between the host computer 100 and the electrical device 1 is installed in the host computer 100. The electrical device 1 includes a communication interface (communication I/F) 33, and communication between the host computer 100 and the CPU 31 is carried out via the communication I/F 33.

An input interface (input I/F) 36 has an input port to which a signal from a power control unit 41 is input, and in particular, to which a signal indicating a detection result regarding a user operation performed on the power key 8a is input. A communication interface (communication I/F) 35 performs data communication with a communication interface (communication I/F) 42 of the power control unit 41.

An input interface (input I/F) 37 has an input port to which a detection result from a sensor 15 is input. The sensor 15 is a sensor that detects, for example, the opening and closing of the cover 3 and the pushing in and pulling out of the stacking portion 4. The detection result of the sensor 15 is input to the input I/F 37 via a processing circuit 45, and the processing circuit 45 is provided in the power control unit 40.

When a plug 14a is inserted into an electrical outlet, a power supply unit (PSU) 14 converts AC voltage from a commercial power source into a DC voltage used by the electrical device 1, such as 32 V or 24 V, and outputs the DC voltage to the power supply unit 20. The state in which the plug 14a has been inserted into an outlet and the PSU 14 has started supplying power is also referred to as a hard-on state.

The power supply unit 20 is a circuit that supplies power to the system control unit 30, and includes a DC/DC converter 21, a regulator 22, and a reset control circuit 23. The DC/DC converter 21 is a power output unit that includes a conversion circuit 21a that converts a DC voltage output from the PSU 14 into a predetermined DC voltage V1 and supplies the converted DC voltage to the system control unit 30, and a control circuit 21b that controls the conversion circuit 21a. The control circuit 21b has an under voltage lockout function (UVLO), monitors the voltage received from the PSU 14, and stops the output of the DC voltage V1 by the conversion circuit 21a when the voltage falls to a threshold voltage (Vth1) or below. The regulator 22 is a power output unit that converts the DC voltage output from the PSU 14 to a predetermined DC voltage V2 and supplies the converted DC voltage to the power control unit 40 and the reset control circuit 23.

The reset control circuit 23 is a circuit that switches between the output of the voltage V1 by the DC/DC converter 21 and stopping the output. Upon receiving a stop output instruction (called a reset instruction) from the power saving control circuit 41, the reset control circuit 23 stops the output of the voltage V1 from DC/DC converter 21 (called a reset state). Furthermore, when the power saving control circuit 41 receives an instruction to cancel the reset state, the reset control circuit 23 causes the DC/DC converter 21 to output the voltage V1.

The power control unit 40 operates while receiving power from the regulator 22, and controls the supply and interruption of power with regard to the system control unit 30 by the power supply unit 20. The power saving control circuit 41 controls the transmission of the reset instruction to the reset control circuit 23 and the cancellation of the reset instruction. In other words, the power state of the system control unit 30 is controlled by the power saving control circuit 41 of the power control unit 40, the power saving state is entered when a reset instruction is output, and the power supply state is entered when the reset state is cancelled.

In the present embodiment, the power saving state is a standby state in which the supply of power to the system control unit 30 is interrupted, and the power consumption of the system control unit 30 is zero. Since the supply and interruption of power with regard to the system control unit 30 is performed by software, in the present embodiment, the power saving state is also called a soft-off state, and the power supply state in which a printing operation can be performed is also called a soft-on state.

Note that the regulator 22 always outputs the voltage V2 as long as power is being supplied from the PSU 14, regardless of whether the regulator 22 is in the reset state or the reset state has been cancelled. The power control unit 40 has a power-on reset function, and stops operating when the voltage supplied by the regulator 22 falls to a threshold voltage (Vth2) or below (called a power-on reset). In the present embodiment, the threshold voltage Vth1 is higher than the threshold voltage Vth2 (Vth1>Vth2).

The power saving control circuit 41 receives an operation detection result pertaining to the power key 8a. The power saving control circuit 41 inputs the operation detection result pertaining to the power key 8a to the input I/F 36 of the system control unit 30. Therefore, in the soft-on state, the system control unit 30 can also recognize the operation state of the power key 8a.

During a hard-on (when the regulator 22 starts supplying the voltage V2), the power saving control circuit 41 controls the output of the reset instruction and the cancellation of the reset state based on the operation detection result pertaining to the power key 8a and a signal received from the system control unit 30 via the communication I/F 42.

The power control unit 40 also includes a counter 43, a storage unit 44, and a processing circuit 45. The counter 43 is capable of counting time. The counter 43 has a slow clock that can count, for example, once every 50 milliseconds, and by counting the clock signal, it is possible to, for example, measure time with low power consumption in the soft-off state.

The storage unit 44 can hold a specific value depending on the operation of the electrical device 1. For example, the storage unit 44 holds information related to a hard-on. The count value of the counter 43 and the value held in the storage unit 44 can be acquired by the system control unit 30 via the communication I/F 42.

The processing circuit 45 is a circuit that has a function of outputting the detection result of the sensor 15 to the system control unit 30, and also has a function of holding the detection result. For example, in the soft-off state, the detection result is held in the processing circuit 45, and in the soft-on state, the system control unit 30 acquires the held detection information. Accordingly, the state of the electrical device 1 in the soft-off state can be recognized by the system control unit 30 in the soft-on state.

In the present embodiment, power consumption is reduced by cutting off the supply of power to the system control unit 30 in the soft-off state. Meanwhile, the power state of the system control unit 30 can be controlled by the power control unit 40, which is configured with a relatively small-scale circuit. This allows the electrical device 1 to achieve necessary functions while also significantly reducing power consumption.

### <Communication>

Communication between the communication I/F 35 of the system control unit 30 and the communication I/F 42 of the power control unit 40 is performed according to a command-based communication protocol. For example, a communication protocol such as Inter integrated Circuit (I2C) or Universal Asynchronous Receiver/Transmitter (UART) can be adopted. A communication protocol such as Peripheral Component Interconnect-Express (PCIe) can also be adopted.

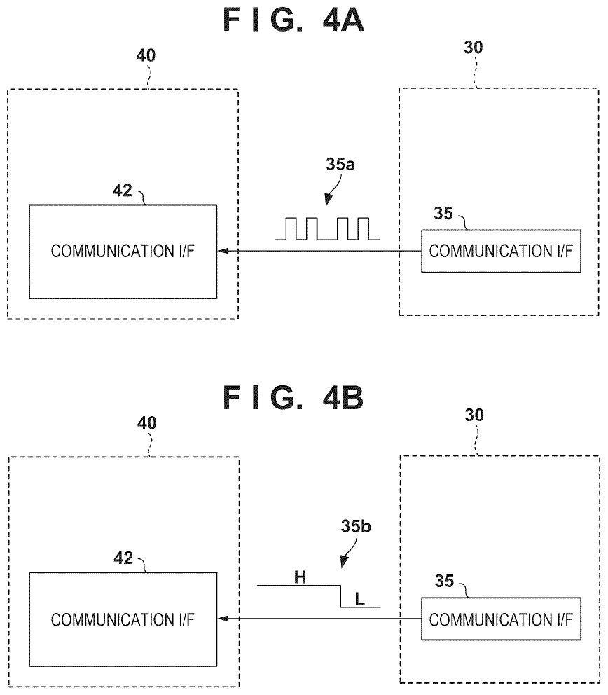

FIG. 4A shows an example of a command 35a transmitted between the communication I/F 35 and the communication I/F 42, and shows an example of a command transmitted from the communication I/F 42 to the communication I/F 35. The command 35a is constituted by a multi-bit signal. FIG. 4B shows, as a comparative example, an example in which communication is performed using a 1-bit signal having a high level and a low level, rather than using a command format. When the signal changes from the high level to the low level, for example, the power control unit 40 is notified of shutdown of the system control unit 30. In the example of FIG. 4B, when a momentary power interruption occurs, for example, the signal input to the communication I/F 42 changes from the high level to the low level, which may cause the power control unit 40 to erroneously recognize a shutdown notification and perform an erroneous operation. By using command-based communication as shown in FIG. 4A, such erroneous recognition and erroneous operation can be prevented.

### Power State Transition Examples

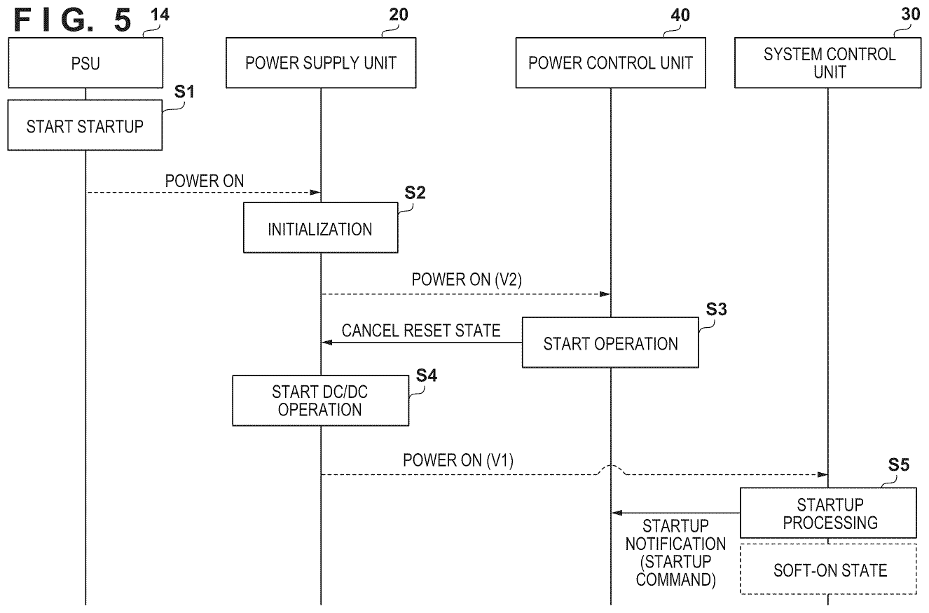

Examples of power state transitions and operations of the system control unit 30 will be described below with reference to FIGS. 5 to 7. FIG. 5 shows an example of operations (a start-up sequence) of the PSU 14, the power supply unit 20, the power control unit 40, and the system control unit 30 during a hard-on.

The PSU 14 starts generating the power voltage used by the electrical device 1 (step S1). The DC voltage generated by the PSU 14 is supplied to the power supply unit 20 (power on), that is to say, power is supplied to the power supply unit 20. The power supply unit 20 is initialized, and the regulator 22 starts outputting the DC voltage V2 (step S2). The DC voltage V2 is supplied to the power control unit 40 (power on (V2)). The power control unit 40 starts operating (step S3), and an internal reset of the power control unit 40 is performed. The power saving control circuit 41 cancels the reset state of the reset control circuit 23 of the power supply unit 20.

When the reset state is cancelled, the reset control circuit 23 causes the DC/DC converter 21 to start operating (step S4). The DC voltage V1 is supplied from the DC/DC converter 21 to the system control unit 30 (power on (V1)). The CPU 31 of the system control unit 30 executes startup processing in accordance with a program stored in the storage unit 32 (step S5). When the startup is complete, the system control unit 30 transmits a startup notification (startup command) to the power control unit 40. The startup notification is transmitted from the communication I/F 35 to the communication I/F 42 in a command format.

Thereafter, when the system control unit 30 detects, for example, a power-on operation pertaining to the power key 8a, the system control unit 30 transitions to the soft-on state. The period from when the DC voltage V1 is supplied to the system control unit 30 until the transition to the soft-on state is sometimes referred to as a standby state. As another example of processing, for example, information set in advance by the user and stored in the storage unit 32 may be read out, and a selection may be made as to whether to set the soft-on state or the soft-off state.

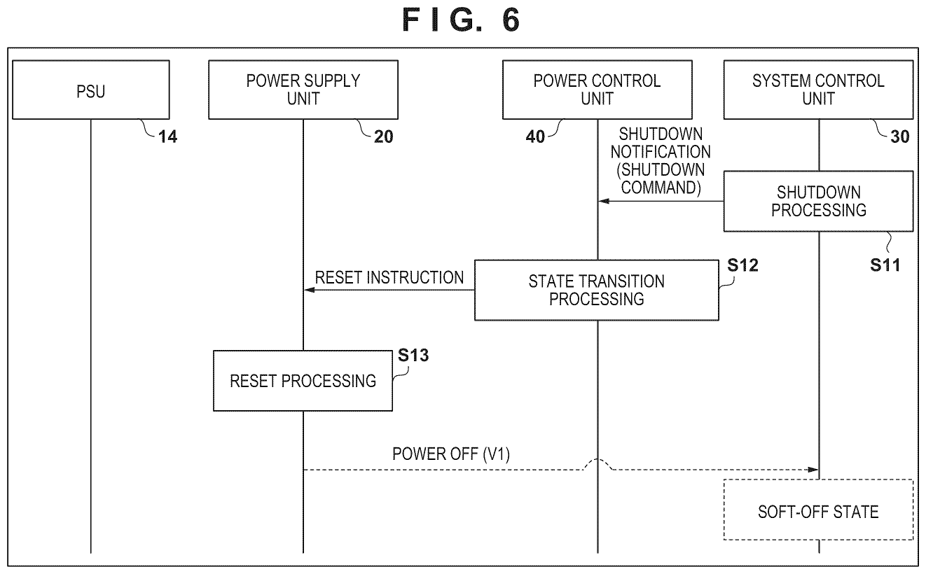

Next, a case where the user performs a power-off operation on the power key 8a in the soft-on state will be described with reference to FIG. 6.

When it is detected that a power-off operation was performed on the power key 8a in the soft-on state, it is then determined that the user has requested shutdown of the electrical device 1, and the system control unit 30 starts shutdown processing (step S11). Shutdown processing is processing in which the system control unit 30 prepares for a power interruption. When shutdown processing is completed, the system control unit 30 transmits a shutdown notification (shutdown command) to the power control unit 40 via the communication I/F 35. The shutdown notification is transmitted from the communication I/F 35 to the communication I/F 42 in a command format.

When the power control unit 40 receives the shutdown notification, the power saving control circuit 41 issues a reset instruction to the power supply unit 20 as state transition processing (step S12). In response to the reset instruction, the reset control circuit 23 of the power supply unit 20 performs reset processing to stop the operation of the DC/DC converter 21 (step S13). The supply of the DC voltage V1 from the DC/DC converter 21 to the system control unit 30 is stopped (power off (V1)). The system control unit 30 transitions to the soft-off state.

Note that in the illustrated example, the system control unit 30 is caused to transition to the soft-off state on the condition that a power-off operation was performed on the power key 8a. However, similar operations may be performed when another condition is satisfied. For example, a configuration is possible in which a soft-off time is set, and when the set time arrives, the system control unit 30 transitions to the soft-off state by the operation in FIG. 6. As another example, the condition may be that no processing request has been received from the user for a certain period of time.

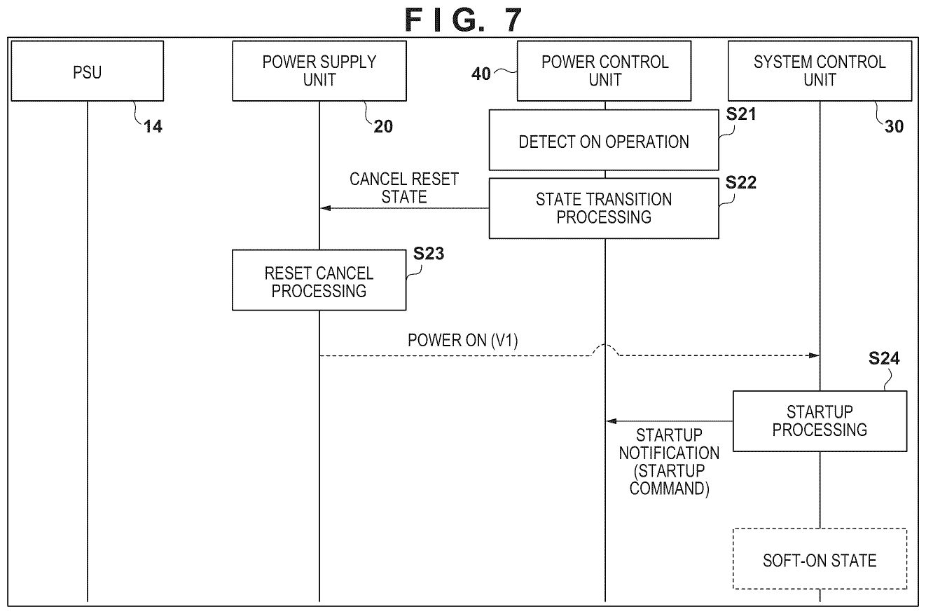

Next, a case where the user performs a power-on operation on the power key 8a in the soft-off state will be described with reference to FIG. 7. Since the system control unit 30 is stopped, the power-on operation is recognized by the power control unit 40 (power saving control circuit 41) (step S21). The power control unit 40 instructs the reset control circuit 23 to cancel the reset state, as state transition processing (step S22). The reset control circuit 23 of the power supply unit 20 performs reset cancel processing and causes the DC/DC converter 21 to start operating. Power is supplied from the DC/DC converter 21 to the system control unit 30 (power on (V1)).

When power is supplied, the CPU 31 of the system control unit 30 executes startup processing in accordance with a program stored in the storage unit 32 (step S24). When the startup is complete, the system control unit 30 transmits a startup notification (startup command) to the power control unit 40. This processing is similar to the processing of step S5 of FIG. 5. The system control unit 30 transitions to the soft-on state. In the power control unit 40, processing related to the startup of the system control unit 30 is executed.

<Operation when Power Outage Occurs>

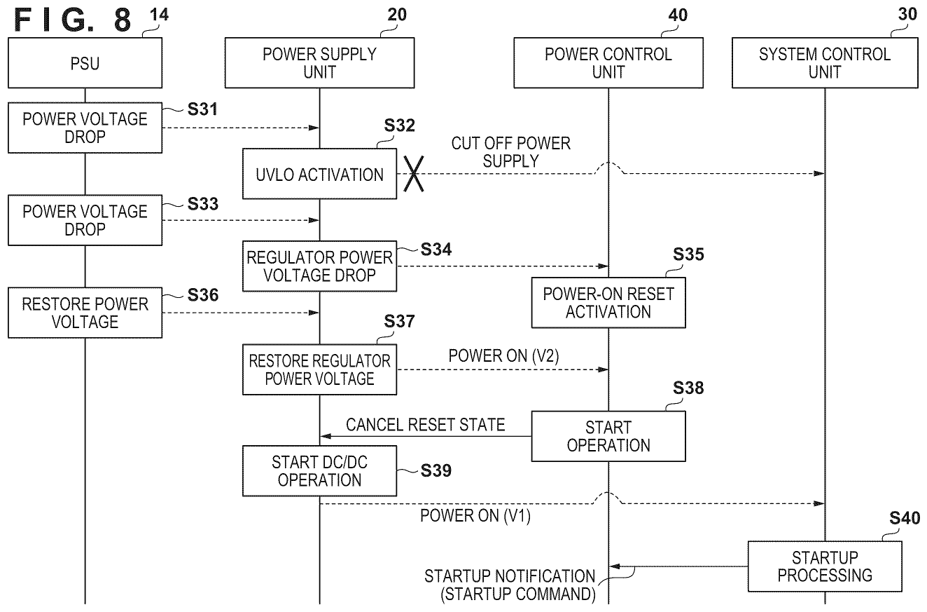

The following describes operations when a commercial power outage occurs. FIG. 8 shows an example of operation of the control unit when a power outage occurs in the soft-on state and the power is then restored. When a power outage occurs, the voltage supplied from the PSU 14 to the power supply unit 20 drops (step S31). When the voltage supplied from the PSU 14 to the power supply unit 20 falls to the threshold voltage Vth1 or below, the UVLO function of the DC/DC converter 21 activates, and output therefrom is stopped (step S32). As a result, power is not supplied to the system control unit 30, and the system control unit 30 stops operating.

When the voltage supplied from the PSU 14 to the power supply unit 20 further drops due to a power outage (step S33), the output voltage of the regulator 22 of the power supply unit 20 drops (step S34). When the voltage supplied from the regulator 22 to the power control unit 40 falls to the threshold voltage Vth2 or below, the power control unit 40 undergoes a power-on reset and enters the stopped state.

Thereafter, when the power is restored, the voltage supplied from the PSU 14 to the power supply unit 20 is restored (step S36), and the output voltage of the regulator 22 of the power supply unit 20 is also restored (step S37). The power control unit 40 starts operating (step S38) similarly to the case of a hard-on in FIG. 5, and an internal reset of the power control unit 40 is performed. The power saving control circuit 41 cancels the reset state of the reset control circuit 23 of the power supply unit 20.

When the reset state is cancelled, the reset control circuit 23 causes the DC/DC converter 21 to start operating (step S39). The DC voltage V1 is supplied from the DC/DC converter 21 to the system control unit 30 (power on (V1)). The CPU 31 of the system control unit 30 executes startup processing in accordance with a program stored in the storage unit 32 (step S40). When the startup is complete, the system control unit 30 transmits a startup notification (startup command) to the power control unit 40.

According to the above processing, even if a commercial power supply outage occurs in the soft-on state, the system control unit 30 can return to the soft-on state when the power is restored.

<Operation when Momentary Power Interruption Occurs>

The following describes operations when a momentary power interruption occurs in a commercial power supply. Here, envision the case where the output voltage of the PSU 14 falls to the threshold voltage Vth1 or below, but the output voltage of the regulator 22 does not fall to the threshold voltage Vth2, and then the commercial power supply is restored.

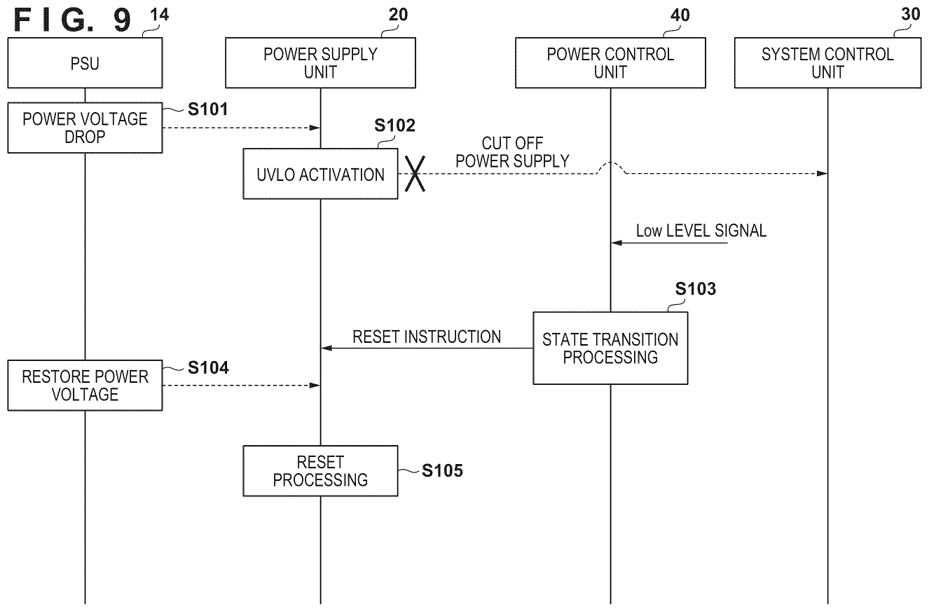

First, as a comparative example, an example in which communication is performed between the communication I/F 35 and the communication I/F 42 using the 1-bit signal illustrated in FIG. 4B will be described with reference to FIG. 9. Here, it is envisioned that transmission of the shutdown notification (corresponding to step S11 in FIG. 6) from the communication I/F 35 to the communication I/F 42 occurs due to the signal changing from the high level to the low level.

When a power outage occurs, the voltage supplied from the PSU 14 to the power supply unit 20 drops (step S101). When the voltage supplied from the PSU 14 to the power supply unit 20 falls to the threshold voltage Vth1 or below, the UVLO function of the DC/DC converter 21 activates, and output therefrom is stopped (step S102). As a result, power is not supplied to the system control unit 30, and the system control unit 30 stops operating. Although a shutdown notification is not output from the system control unit 30, the high level signal input to the communication I/F 42 changes to the low level signal. At this stage, the power control unit 40 is not yet in the power-on reset state, but rather is in the normal operating state. When the low level signal is input to the communication I/F 42, the power control unit 40 erroneously recognizes that the shutdown notification has been issued from the system control unit 30. As a result, the power saving control circuit 41 transmits a reset instruction to the power supply unit 20 as state transition processing (step S103).

Thereafter, when the power is restored, the voltage supplied from the PSU 14 to the power supply unit 20 is restored (step S104). However, since the power control unit 40 is not in the power-on reset state, the reset state is not cancelled as when the power is turned on. The power supply unit 20 enters the reset state, no power is supplied to the system control unit 30, and the system control unit 30 does not start up.

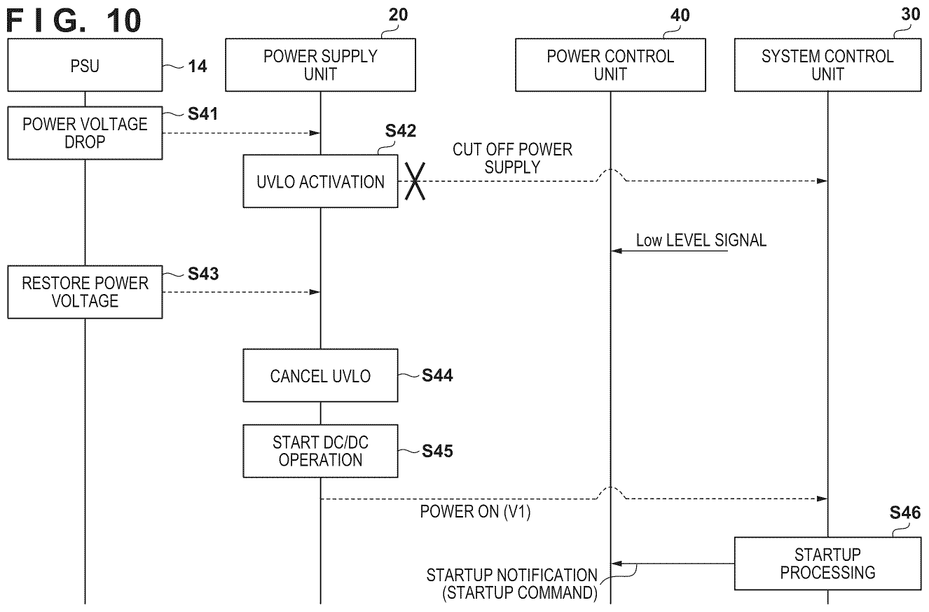

Next, operation when a momentary power interruption occurs in the present embodiment will be described with reference to FIG. 10. When a power outage occurs, the voltage supplied from the PSU 14 to the power supply unit 20 drops (step S41). When the voltage supplied from the PSU 14 to the power supply unit 20 falls to the threshold voltage Vth1 or below, the UVLO function of the DC/DC converter 21 activates, and output therefrom is stopped (step S42). As a result, power is not supplied to the system control unit 30, and the system control unit 30 stops operating. The signal input to the communication I/F 42 of the power control unit 40 changes to the low level. At this stage, the power control unit 40 is not yet in the power-on reset state, but rather is in the normal operating state. However, unlike the example in FIG. 9, communication between the communication I/F 35 and the communication I/F 42 is command-based communication, and therefore even if the signal input to the communication I/F 42 changes to the low level, the change to the low level is not erroneously recognized as the shutdown notification. Therefore, the power control unit 40 does not issue a reset instruction to the power supply unit 20.

Thereafter, when the power is restored, the voltage supplied from the PSU 14 to the power supply unit 20 is restored (step S43). In the DC/DC converter 21, the UVLO function is cancelled (step S44), and the DC/DC converter 21 starts operating (step S45). The DC voltage V1 is supplied from the DC/DC converter 21 to the system control unit 30 (power on (V1)). The CPU 31 of the system control unit 30 executes startup processing in accordance with a program stored in the storage unit 32 (step S46). When the startup is complete, the system control unit 30 transmits a startup notification (startup command) to the power control unit 40.

According to the above processing, even if a commercial power momentary interruption occurs in the soft-on state, the system control unit 30 can return to the soft-on state when the power is restored. As described above, according to the present embodiment, it is possible to provide a technology that is related to power state control and prevent an erroneous operation from being performed when a momentary power interruption occurs.

### OTHER EMBODIMENTS

In the above embodiment, an inkjet printing apparatus is illustrated as an example of an electrical device, but the present invention can also be applied to other electrical devices.

In the above embodiment, the power supply unit 20 and the power control unit 40 are configured as separate ICs, but they may also be configured as a single IC.

In the above embodiment, there is one type of soft-on state, but the soft-on state may further have two types, namely a normal power supply state and a power saving state.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electrical device comprising:
a controlling unit configured to control the electrical device;
a power supplying unit configured to supply power to the controlling unit; and
a power controlling unit configured to control supply and interruption of power with regard to the controlling unit by the power supplying unit,
wherein the controlling unit and the power controlling unit are configured to perform command-based communication, and
the power controlling unit instructs the power supplying unit to interrupt the supply of power to the controlling unit based on a shutdown command received from the controlling unit.

2. The electrical device according to claim 1, wherein
when a power-on occurs, the power controlling unit instructs the power supplying unit to supply power to the controlling unit, and
the controlling unit transmits the shutdown command to the power controlling unit based on a power-off instruction from a user.

3. The electrical device according to claim 1, wherein
in a case where a power voltage of the power supplying unit falls to a first voltage or lower, the power supplying unit interrupts the supply of power to the controlling unit,
in a case where the power voltage of the power controlling unit falls to a second voltage or lower, the power controlling unit stops operating, and
the first voltage is higher than the second voltage.

4. The electrical device according to claim 1, wherein
the power supplying unit includes:
a first power output unit configured to output power to be supplied to the controlling unit, and
a second power output unit configured to output power to be supplied to the power controlling unit.

5. The electrical device according to claim 1, wherein
the electrical device is a printing apparatus configured to perform printing by ejecting a liquid onto a printing medium to perform printing.

6. The electrical device according to claim 1, wherein
the shutdown command is constituted by a multi-bit signal.
